(19) United States
(12) Patent Application Publication
(10) Pub. No.: US 2013/0169586 A1
(43) Pub. Date: Jul. 4, 2013

(54) TOUCH SYSTEM FOR INCREASING A REPORT RATE AND METHOD FOR INCREASING A REPORT RATE OF A TOUCH SYSTEM

(71) Applicants: Bo-Wei Lan, Taipei City (TW); Chun-Chieh Wang, Chiayi County (TW)

(72) Inventors: Bo-Wei Lan, Taipei City (TW); Chun-Chieh Wang, Chiayi County (TW)

(21) Appl. No.: 13/413,657

(22) Filed: Mar. 7, 2012

(30) Foreign Application Priority Data
Dec. 28, 2011 (TW) 100149212

(51) Int. Cl. G06F 3/044; G06F 3/045; G06F 3/041

(52) U.S. Cl. 345/174; 345/173

(57) ABSTRACT

A touch system for increasing a report rate includes a touch panel and a readout circuit. The touch panel is used for being touched by at least one object. A first axial direction of the touch panel has N first sensing lines and a second axial direction of the touch panel has M second sensing lines. The readout circuit is used for transmitting driving signals to each at least two first sensing lines of the N first sensing lines simultaneously, receiving sensing signals corresponding to the at least two first sensing lines through the M second sensing lines in turn, and calculating and outputting coordinates of at least one object touching the touch panel to a host according to the sensing signals corresponding to the at least two first sensing lines. The driving signals corresponding to the at least two first sensing lines partially overlap each other.

### BACKGROUND OF THE INVENTION

1. Field of the Invention

The present invention relates to a touch system for increasing a report rate and a method for increasing a report rate of a touch system, and particularly to a touch system and a method that can utilize a readout circuit to simultaneously transmit driving signals to each of at least two first sensing lines of a plurality of first sensing lines of a touch panel in turn to increase a report rate of the touch panel.

2. Description of the Prior Art

In the present variety of touch panels, mutual capacitance touch panels are mainstream touch panels. Please refer to FIG. 1. FIG. 1 is a diagram illustrating a mutual capacitance touch panel 100. As shown in FIG. 1, a driving method of the mutual capacitance touch panel 100 utilizes voltage scanning signals or current scanning signals to scan sensing lines in a Y direction (or an X direction) of the mutual capacitance touch panel 100, and then to capture at least one sensing signal of at least one touch point in the X direction (or the Y direction) of the mutual capacitance touch panel 100. In the Y direction, the mutual capacitance touch panel 100 utilizes voltage scanning signals or current scanning signals to scan from the sensing line Y1 to the sensing line YN in turn. But, in the X direction, the mutual capacitance touch panel 100 captures at least one sensing signal of at least one touch point from all sensing lines X1 to XM simultaneously to determine coordinates of the at least one touch point, where N and M are integers. However, when a plurality of objects touch the mutual capacitance touch panel 100, motion trajectories of the plurality of objects touching the mutual capacitance touch panel 100 are not smooth due to a decrease in the report rate of the mutual capacitance touch panel 100, resulting in graphics displayed on the mutual capacitance touch panel 100 being distorted.

### SUMMARY OF THE INVENTION

An embodiment provides a touch system for increasing a report rate. The touch system includes a touch panel and a readout circuit. The touch panel is used for being touched by at least one object, a first axial direction of the touch panel has N first sensing lines, and a second axial direction of the touch panel has M second sensing lines, where each first sensing line corresponds to M sensing units, each second sensing line corresponds to N sensing units, and N and M are integers. The readout circuit is used for transmitting driving signals to each at least two first sensing lines of the N first sensing lines simultaneously, receiving sensing signals corresponding to the at least two first sensing lines through the M second sensing lines in turn, and calculating and outputting coordinates of the at least one object touching the touch panel to a host according to the sensing signals corresponding to the at least two first sensing lines. The driving signals corresponding to the at least two first sensing lines partially overlap each other.

Another embodiment provides a method for increasing a report rate of a touch system. A first axial direction of a touch panel of the touch system has N first sensing lines and a second axial direction of the touch panel of the touch system has M second sensing line, where each first sensing line corresponds to M sensing units, each second sensing line corresponds to N sensing units, and N and M are integers. The method includes transmitting driving signals to each at least two first sensing lines of the N first sensing lines simultaneously; receiving sensing signals corresponding to the at least two first sensing lines through the M second sensing lines in turn; and calculating and outputting coordinates of at least one object touching the touch panel according to the sensing signals corresponding to the at least two first sensing lines.

The present invention provides a touch system for increasing a report rate and a method for increasing a report rate of a touch system. The touch system and the method utilize a microcontroller to control a multiplexer to transmit driving signals to each two first sensing lines of N first sensing lines of a touch pane simultaneously, and to receive sensing signals corresponding to the each two first sensing lines through M second sensing lines of the touch panel in turn. Compared to the prior art, because the present invention can return more touch points to a host within a predetermined period, the present invention can increase the report rate of the touch system. Thus, when a plurality of objects touch the touch panel, motion trajectories of the plurality of objects touching the touch panel are smoother due to increase in the report rate of the touch system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a mutual capacitance touch panel.

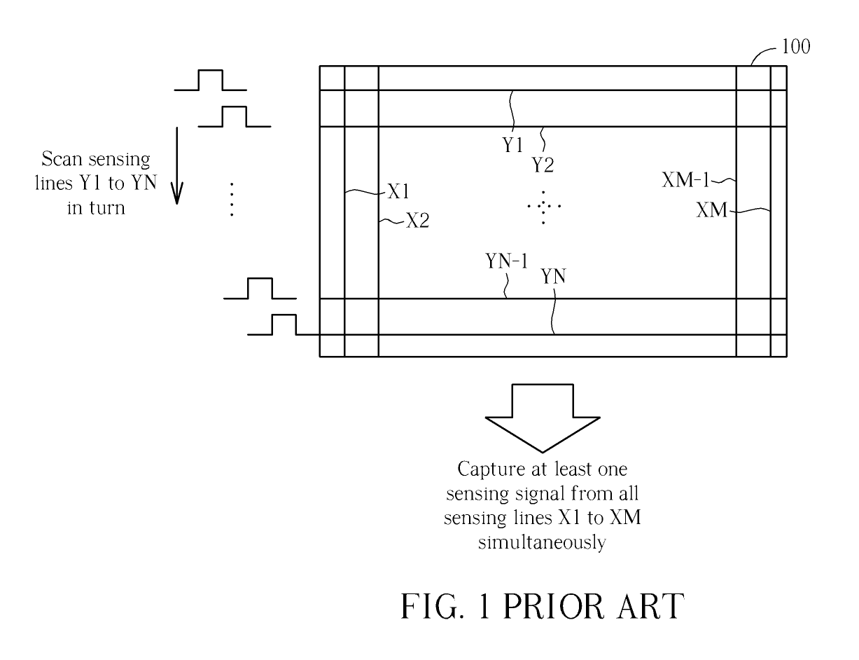

FIG. 2 is a diagram illustrating a touch system for increasing a report rate according to an embodiment.

FIG. 3 is a timing diagram illustrating the microcontroller controlling the multiplexer to transmit driving signals to each two first sensing lines of the 4 first sensing lines simultaneously, and controlling the multiplexer to receive sensing signals corresponding to the 4 first sensing lines through the M second sensing lines in turn.

FIG. 4 is a flowchart illustrating a method for increasing a report rate of the touch system according to another embodiment.

### DETAILED DESCRIPTION

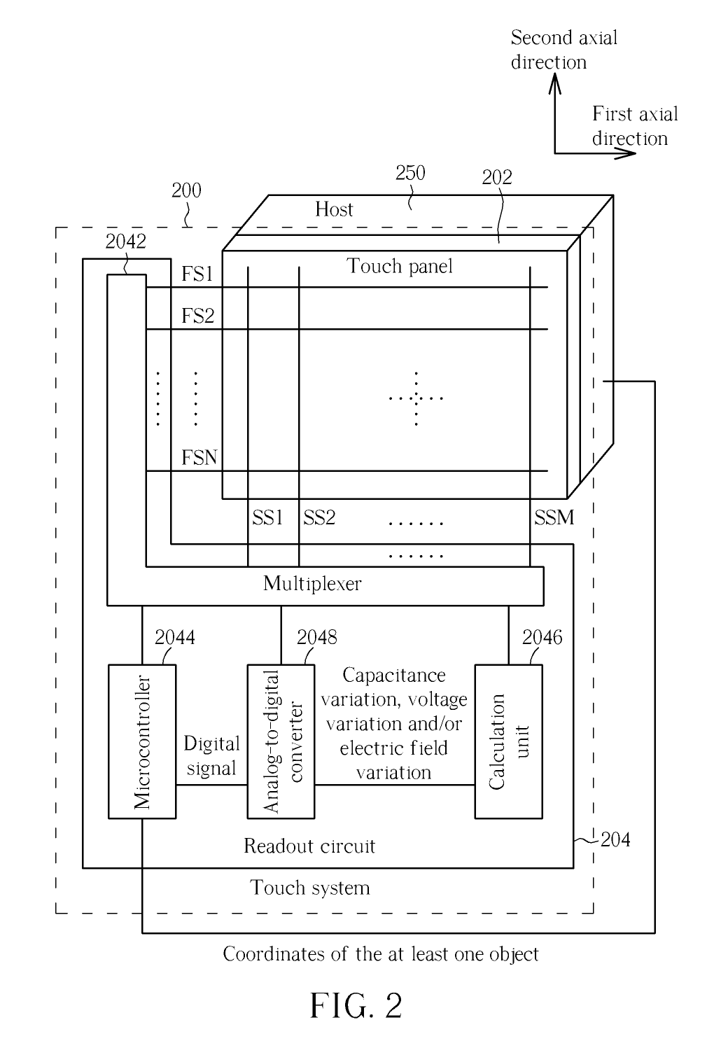

Please refer to FIG. 2. FIG. 2 is a diagram illustrating a touch system 200 for increasing a report rate according to an embodiment. The touch system 200 includes a touch panel 202 and a readout circuit 204. The touch panel 202 is used for being touched by at least one object. A first axial direction of the touch panel 202 has N first sensing lines FS1 to FSN and a second axial direction of the touch panel 202 has M second sensing lines SS1 to SSM, where each first sensing line of the N first sensing lines FS1 to FSN corresponds to M sensing units, each second sensing line of the M second sensing lines SS1 to SSM corresponds to N sensing units, N and M are integers, and N and M vary with a characteristic of the touch panel 202 and a specification of the readout circuit 204. In addition, the touch panel 202 can be a projected capacitive touch panel or a resistive touch panel, where the touch panel 202 is a mutual capacitance touch panel when the touch panel 202 is a projected capacitive touch panel. The readout circuit 204 is used for transmitting driving signals to each two first sensing lines of the N first sensing lines FS1 to FSN simultaneously, receiving sensing signals (raw data) corresponding to each two first sensing lines through the M second sensing lines SS1 to SSM in turn, and calculating and outputting coordinates of the at least one object touching the touch panel 202 to a host 250 according to the sensing signals corresponding to each two first sensing lines, where the driving signals corresponding to each two first sensing lines partially overlap each other. But, the present invention is not limited to the readout circuit 204 simultaneously transmitting driving signals to each two first sensing lines of the N first sensing lines FS1 to FSN in turn. That is to say, the readout circuit 204 can simultaneously transmit driving signals to each at least two first sensing lines of the N first sensing lines FS1 to FSN in turn. In addition, in another embodiment of the present invention, the touch system 200 includes the host 250.

As shown in FIG. 2, the readout circuit 204 includes a multiplexer 2042, a microcontroller 2044, a calculation unit 2046, and an analog-to-digital converter 2048. As shown in FIG. 2, the microcontroller 2044 is coupled to the multiplexer 2042 for controlling the multiplexer 2042 to transmit driving signals to each two first sensing lines of the N first sensing lines FS1 to FSN simultaneously, and receiving sensing signals corresponding to each two first sensing lines through the M second sensing lines SS1 to SSM in turn. The calculation unit 2046 is coupled to the multiplexer 2042 for calculating capacitance variation, voltage variation and/or electric field variation of sensing units corresponding to each two first sensing lines according to sensing signals corresponding to each two first sensing lines. The analog-to-digital converter 2048 is coupled to the calculation unit 2046 for generating digital signals of sensing units corresponding to each two first sensing lines according to capacitance variation, voltage variation and/or electric field variation of sensing units corresponding to each two first sensing lines. The microcontroller 2044 calculates and outputs coordinates of at least one object touching the touch panel 202 to the host 250 (such as a tablet PC, a smart phone or a touch electronic product) according to digital signals of sensing units corresponding to each two first sensing lines. Then, the host 250 can execute a corresponding operation according to coordinates of at least one object touching the touch panel 202. For example, the host 250 can execute a corresponding program according to coordinates of at least one object touching the touch panel 202.

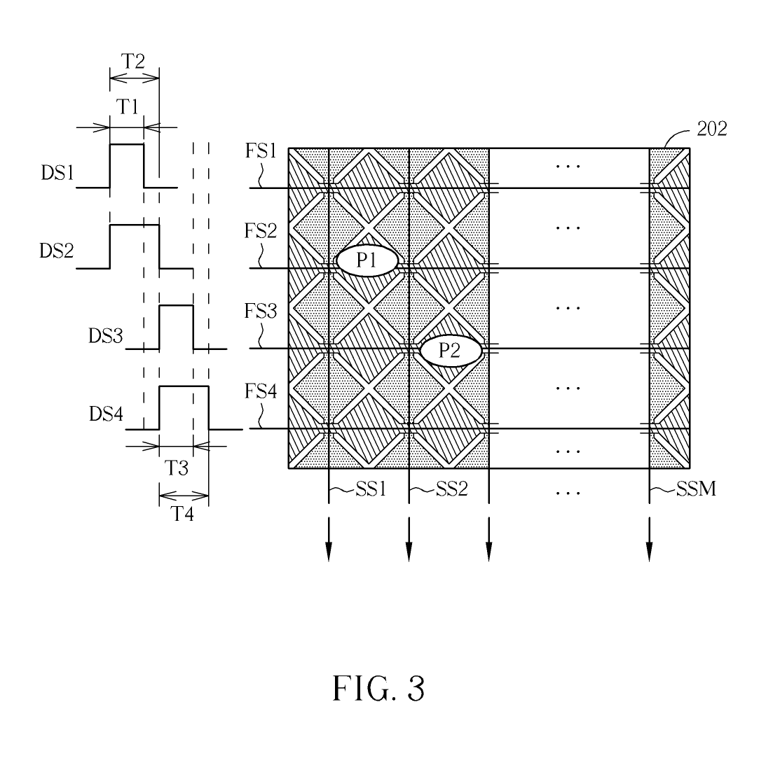

Please refer to FIG. 3. FIG. 3 is a timing diagram illustrating the microcontroller 2044 controlling the multiplexer 2042 to transmit driving signals DS1, DS2 to the first sensing lines FS1, FS2 of the 4 first sensing lines FS1, FS2, FS3, and FS4 simultaneously, and to transmit driving signals DS3, DS4 to the first sensing lines FS3, FS4 of the 4 first sensing lines FS1, FS2, FS3, and FS4 simultaneously, and controlling the multiplexer 2042 to receive sensing signals corresponding to the 4 first sensing lines FS1, FS2, FS3, and FS4 through the M second sensing lines SS1 to SSM in turn. As shown in FIG. 3, when the multiplexer 2042 transmits the driving signals DS1, DS2 to drive the first sensing lines FS1, FS2 and transmits the driving signals DS3, DS4 to drive the first sensing lines FS3, FS4 (the multiplexer 2042 first drives the first sensing lines FS1, FS2 simultaneously, then drives the first sensing lines FS3, FS4 simultaneously, and operational principles of other first sensing lines of the touch panel 202 are the same as those of the 4 first sensing lines FS1, FS2, FS3, and FS4, so further description thereof is omitted for simplicity), an interval T1 is length of the driving signal DS1 of the first sensing line FS1, an interval T2 is length of the driving signal DS2 of the first sensing line FS2, an interval T3 is length of the driving signal DS3 of the first sensing line FS3, and an interval T4 is length of the driving signal DS4 of the first sensing line FS4, where the interval T2 is greater than the interval T1, and the interval T4 is greater than the interval T3. That is to say, the driving signal DS1 of the first sensing line FS1 and the driving signal DS2 of the first sensing line FS2 partially overlap each other. But, the present invention is not limited to the interval T2 being greater than the interval T1, and the interval T4 being greater than the interval T3. In another embodiment of the present invention, the interval T1 is greater than the interval T2, and the interval T3 is greater than the interval T4. As shown in FIG. 3, if a finger of a user touches a position P1 of the touch panel 202, when the driving signal DS1 of the first sensing line FS1 is finished, the calculation unit 2046 knows that capacitances, voltages and/or electric fields of sensing units corresponding to the first sensing line FS1 are not changed according to the sensing signal corresponding to the first sensing line FS1 through the M second sensing lines SS1 to SSM received by the multiplexer 2042 (because the position P1 of the touch panel 202 does not correspond to the sensing units of the first sensing line FS1). But, when the driving signal DS2 of the first sensing line FS2 is finished, the calculation unit 2046 knows that capacitances, voltages and/or electric fields of sensing units corresponding to the first sensing line FS2 are changed according to the sensing signal corresponding to the first sensing line FS2 through the M second sensing lines SS1 to SSM received by the multiplexer 2042 (because the position P1 of the touch panel 202 corresponds to the sensing units of the first sensing line FS2). Therefore, the touch system 200 can utilize a characteristic of the interval T2 being greater than the interval T1 to determine the position P1 of the touch panel 202 touched by the finger of the user. Similarly, if the finger of the user touches a position P2 of the touch panel 202, when the driving signal DS3 of the first sensing line FS3 is finished, the calculation unit 2046 knows that capacitances, voltages and/or electric fields of sensing units corresponding to the first sensing line FS3 are changed according to the sensing signal corresponding to the first sensing line FS3 through the M second sensing lines SS1 to SSM received by the multiplexer 2042 (because the position P2 of the touch panel 202 corresponds to the sensing units of the first sensing line FS3). But, when the driving signal DS4 of the first sensing line FS4 is finished, the calculation unit 2046 knows that capacitances, voltages and/or electric fields of sensing units corresponding to the first sensing line FS4 are not changed according to the sensing signal corresponding to the first sensing line FS4 through the M second sensing lines SS1 to SSM received by the multiplexer 2042 (because the position P2 of the touch panel 202 does not correspond to the sensing units of the first sensing line FS4). Therefore, the touch system 200 can utilize a characteristic of the interval T4 being greater than the interval T3 to determine the position P2 of the touch panel 202 touched by the finger of the user. Further, driving methods of other first sensing lines of the N first sensing lines FS1 to FSN of the touch panel 200 are the same as those of the 4 first sensing lines FS1, FS2, FS3, and FS4, so further description thereof is omitted for simplicity.

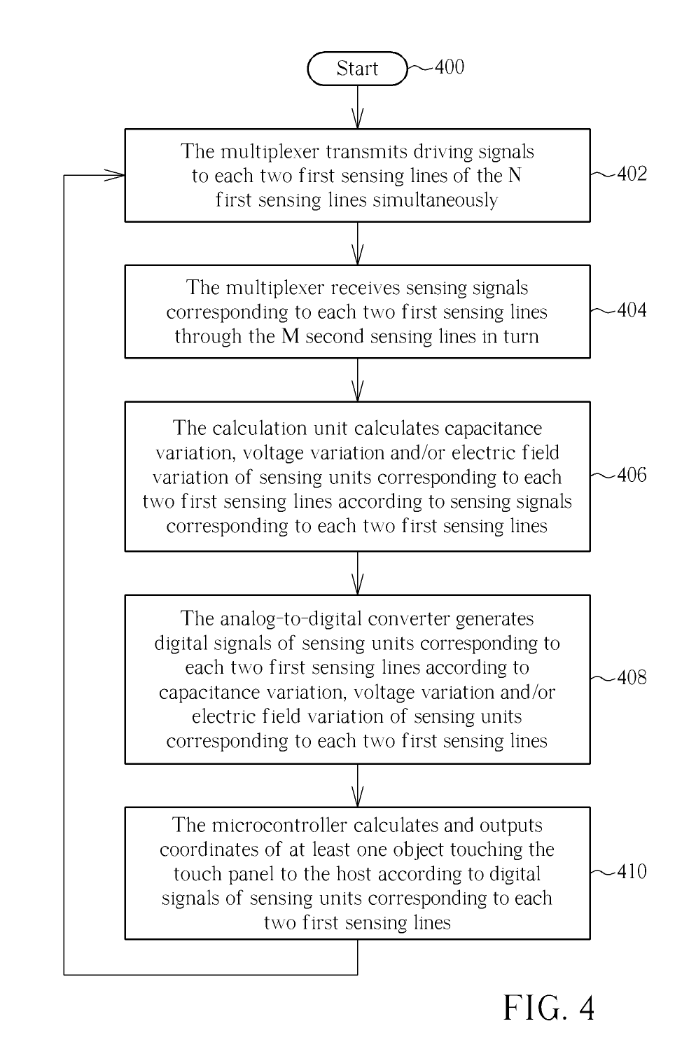

Please refer to FIG. 4, FIG. 2, and FIG. 3. FIG. 4 is a flowchart illustrating a method for increasing a report rate of the touch system 200 according to another embodiment. The method in FIG. 4 is illustrated using the touch system 200 in FIG. 2. Detailed steps are as follows:

Step 400: Start.

Step 402: The multiplexer 2042 transmits driving signals to each two first sensing lines of the N first sensing lines FS1 to FSN simultaneously.

Step 404: The multiplexer 2042 receives sensing signals corresponding to each two first sensing lines through the M second sensing lines SS1 to SSM in turn.

Step 406: The calculation unit 2046 calculates capacitance variation, voltage variation and/or electric field variation of sensing units corresponding to each two first sensing lines according to sensing signals corresponding to each two first sensing lines.

Step 408: The analog-to-digital converter 2048 generates digital signals of sensing units corresponding to each two first sensing lines according to capacitance variation, voltage variation and/or electric field variation of sensing units corresponding to each two first sensing lines.

Step 410: The microcontroller 2044 calculates and outputs coordinates of at least one object touching the touch panel 202 to the host 250 according to digital signals of sensing units corresponding to each two first sensing lines; go to Step 402.

As shown in FIG. 3, in Step 402, the microcontroller 2044 controls the multiplexer 2042 to transmit driving signals to each two first sensing lines of the N first sensing lines FS1 to FSN simultaneously (the multiplexer 2042 first utilizes the driving signals DS1, DS2 to drive the first sensing lines FS1, FS2 simultaneously, then utilizes the driving signals DS3, DS4 to drive the first sensing lines FS3, FS4 simultaneously, and operational principles of other first sensing lines of the touch panel 200 are the same as those of the 4 first sensing lines FS1, FS2, FS3, and FS4, so further description thereof is omitted for simplicity). In Step 404, the microcontroller 2044 controls the multiplexer 2042 to receive sensing signals corresponding to each two first sensing lines through the M second sensing lines SS1 to SSM in turn. That is to say, when the driving signal DS1 of the first sensing line FS1 is finished earlier than the driving signal DS2 of the first sensing line FS2 (as shown in FIG. 3), the microcontroller 2044 first controls the multiplexer 2042 to receive sensing signals corresponding to the first sensing line FS1 through the M second sensing lines SS1 to SSM, then controls the multiplexer 2042 to receive sensing signals corresponding to the first sensing line FS2 through the M second sensing lines SS1 to SSM. In Step 406, the calculation unit 2046 calculates capacitance variation, voltage variation and/or electric field variation of sensing units corresponding to each two first sensing lines according to sensing signals corresponding to each two first sensing lines. That is to say, the calculation unit 2046 calculates capacitance variation, voltage variation and/or electric field variation of sensing units corresponding to each two first sensing lines according to raw data of sensing units corresponding to each two first sensing line. In addition, as shown in FIG. 3, if the finger of the user touches the position P1 of the touch panel 202, when the driving signal DS1 of the first sensing line FS1 is finished, the calculation unit 2046 knows that capacitances, voltages and/or electric fields of sensing units corresponding to the first sensing line FS1 are not changed according to the sensing signal corresponding to the first sensing line FS1 through the M second sensing lines SS1 to SSM received by the multiplexer 2042 (because the position P1 of the touch panel 202 does not correspond to the sensing units of the first sensing line FS1). But, when the driving signal DS2 of the first sensing line FS2 is finished, the calculation unit 2046 knows that capacitances, voltages and/or electric fields of sensing units corresponding to the first sensing line FS2 are changed according to the sensing signal corresponding to the first sensing line FS2 through the M second sensing lines SS1 to SSM received by the multiplexer 2042 (because the position P1 of the touch panel 202 corresponds to the sensing units of the first sensing line FS2). Therefore, the touch system 200 can utilize the characteristic of the interval T2 being greater than the interval T1 to determine the position P1 of the touch panel 202 touched by the finger of the user. In Step 410, as shown in FIG. 3, after the microcontroller 2044 outputs coordinates of objects touching the touch panel 202 (the coordinates of the position P1 or the coordinates of the position P2) to the host 250, the host 250 can execute a corresponding operation according to the coordinates of the objects touching the touch panel 202. For example, as shown in FIG. 3, the host 250 can execute a corresponding program according to the coordinates of the position P1 where the finger of the user touches the touch panel 202, or execute another corresponding program according to the coordinates of the position P2 where the finger of the user touches the touch panel 202.

To sum up, the touch system for increasing the report rate and the method for increasing the report rate of the touch system utilize the microcontroller to control the multiplexer to transmit driving signals to each two first sensing lines of the N first sensing lines simultaneously, and to receive sensing signals corresponding to each two first sensing lines through the M second sensing lines in turn. Compared to the prior art, because the present invention can return more touch points to the host within a predetermined period, the present invention can increase the report rate of the touch system. Thus, when a plurality of objects touch the touch panel of the present invention, motion trajectories of the plurality of objects touching the touch panel are smoother due to increase in the report rate of the touch system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch system for increasing a report rate, the touch system comprising:
a touch panel for being touched by at least one object, a first axial direction of the touch panel having N first sensing lines and a second axial direction of the touch panel having M second sensing lines, wherein each first sensing line corresponds to M sensing units, each second sensing line corresponds to N sensing units, and N and M are integers; and
a readout circuit for transmitting driving signals to each at least two first sensing lines of the N first sensing lines simultaneously, receiving sensing signals corresponding to the at least two first sensing lines through the M second sensing lines in turn, and calculating and outputting coordinates of the at least one object touching the touch panel to a host according to the sensing signals corresponding to the at least two first sensing lines;
wherein the driving signals corresponding to the at least two first sensing lines partially overlap each other.

2. The touch system of claim 1, wherein the touch panel is a projected capacitive touch panel.

3. The touch system of claim 2, wherein the projected capacitive touch panel is a mutual capacitance touch panel.

4. The touch system of claim 1, wherein the touch panel is a resistive touch panel.

5. The touch system of claim 1, wherein the readout circuit comprises:
a multiplexer;
a microcontroller for controlling the multiplexer to transmit the driving signals to the at least two first sensing lines simultaneously, and receiving the sensing signals corresponding to the at least two first sensing lines through the M second sensing lines in turn;
a calculation unit coupled to the multiplexer for calculating capacitance variation, voltage variation and/or electric field variation of sensing units corresponding to the at least two first sensing lines according to the sensing signals corresponding to the at least two first sensing lines; and
an analog-to-digital converter coupled to the calculation unit for generating digital signals of the sensing units corresponding to the at least two first sensing lines according to the capacitance variation, the voltage variation and/or the electric field variation of the sensing units corresponding to the at least two first sensing lines;
wherein the microcontroller calculates and outputs the coordinates of the at least one object according to the digital signals of the sensing units corresponding to the at least two first sensing lines.

6. A method for increasing a report rate of a touch system, a first axial direction of a touch panel of the touch system having N first sensing lines and a second axial direction of the touch panel of the touch system having M second sensing lines, wherein each first sensing line corresponds to M sensing units, each second sensing line corresponds to N sensing units, and N and M are integers, the method comprising:
transmitting driving signals to each at least two first sensing lines of the N first sensing lines simultaneously;
receiving sensing signals corresponding to the at least two first sensing lines through the M second sensing lines in turn; and
calculating and outputting coordinates of at least one object touching the touch panel to a host according to the sensing signals corresponding to the at least two first sensing lines;
wherein the driving signals corresponding to the at least two first sensing lines partially overlap each other.

7. The method of claim 6, wherein calculating and outputting the coordinates of the at least one object touching the touch panel to the host according to the sensing signals corresponding to the at least two first sensing lines according to the sensing signals corresponding to the at least two first sensing lines comprises:
calculating capacitance variation, voltage variation and/or electric field variation of sensing units corresponding to the at least two first sensing lines according to the sensing signals corresponding to the at least two first sensing lines;
generating digital signals of the sensing units corresponding to the at least two first sensing lines according to the capacitance variation, the voltage variation and/or the electric field variation of the sensing units corresponding to the at least two first sensing lines; and
calculating and outputting the coordinates of the at least one object according to the digital signals of the sensing units corresponding to the at least two first sensing lines.

8. The method of claim 6, wherein the touch panel is a projected capacitive touch panel.

9. The method of claim 8, wherein the projected capacitive touch panel is a mutual capacitance touch panel.

10. The method of claim 6, wherein the touch panel is a resistive touch panel.
